(19) United States
(12) Patent Application Publication
(10) Pub. No.: US 2019/0041808 A1
(43) Pub. Date: Feb. 7, 2019

(54) CONTROLLER AND MACHINE LEARNING DEVICE

(71) Applicant: FANUC CORPORATION, Yamanashi (JP)

(72) Inventors: Keita Hada, Yamanashi (JP); Kazuomi Maeda, Yamanashi (JP)

(73) Assignee: FANUC CORPORATION, Yamanashi (JP)

(21) Appl. No.: 16/053,235

(22) Filed: Aug. 2, 2018

(30) Foreign Application Priority Data
Aug. 7, 2017 (JP) 2017-152492

(51) Int. Cl. G05B 13/02; G05B 19/418

(52) U.S. Cl. CPC G05B 13/027; G05B 19/41875

(57) ABSTRACT

A controller predicting a workpiece processing result by a processing machine includes a machine learning device learning a relationship between a change in state quantity indicating a processing state and a processing result. The machine learning device includes a state observation unit observing time-series data of the state quantity including at least one of a state of the processing machine and a state of a surrounding environment as a state variable indicating a current state of the environment, a determination data acquisition unit acquiring determination data indicating the processing result, and a learning unit learning the change in state quantity indicating the processing state and the processing result in association with each other by using the state variable and the determination data.

### BACKGROUND OF THE INVENTION

### 1. Field of the Invention

The present invention relates to a controller and a machine learning device, and particularly, to a controller and a machine learning device capable of predicting influence of a change in state quantity on a processing result by machine learning.

### 2. Description of the Related Art

In some cases, the same type of workpieces may be repeatedly processed by using a processing machine (a machine tool such as a cutting machine, an injection molding machine, a robot for performing finish processing, or the like). At this time, even if the processing conditions are the same, the shape of the workpiece to be processed is changed due to a change in state quantity (an ambient temperature, a motor current value, a motor load, sound, light, or the like) other than processing conditions. For example, in some cases, the processing machine may be thermally expanded due to a change in ambient temperature or heat generated by a motor, and thus, the processing accuracy maybe influenced. As a result of such influence, in some cases, the required dimensions may not be realized, and a processing failure may occur. Therefore, the materials and the like may be wasted, and the working man-hours for retry may be unnecessarily increased.

JP 2566345 B1 discloses a method for predicting a shape of a workpiece after completion of processing by storing theoretical knowledge related to influence of heat or force generated at the time of the processing on processing accuracy in a database in advance and referring to a state quantity detected by a sensor and the database during the processing. In addition, the Patent Document discloses a method of correcting a command of a numerical controller by comparing the predicted machining shape and target shape.

In addition, Japanese Parent Application Laid-Open No. 2008-027210 A discloses a method for defining an external disturbance influencing processing accuracy in advance and interrupting processing when an external disturbance exceeding a set threshold value is detected. Therefore, the processing can be interrupted before the defective product is produced, and the waste of materials and man-hours can be prevented.

However, according to the method disclosed in JP 2566345 B1, it is necessary to prepare a database in which the theoretical knowledge is stored in advance. Particularly, in actual processing since a plurality of state quantities influence complicatedly, it is difficult to theoretically formulate the relationship between the state quantity and the processing result. In addition, in the method disclosed in JP 2566345 B1, since a deviation caused by the change in state quantity is corrected by correcting a command value of NC, and thus, since the fundamental cause of the deviation is not solved, the sane deviation can continue to occur.

In the method disclosed in Japanese Patent Application Laid-Open No. 2008-027210 A, it is necessary to set a threshold in advance. Depending on the setting, for example, there is a possibility of causing inappropriate operation such that processing is interrupted even though an external disturbance is not so great to influence the acceptability of the processing result, and thus, unnecessary man-hours are taken.

### SUMMARY OF THE INVENTION

In order to solve such problems, an object of the invention is to provide a controller and a machine learning device capable of predicting influence of a change in state quantity on a processing result by machine learning.

A controller according to an embodiment of the invention is a controller predicting a processing result for a workpiece by a processing machine, the controller including: a machine learning device learning a relationship between a change in state quantity indicating a processing state and a processing result, wherein the machine learning device includes: a state observation unit observing time-series data of the state quantity including at least one of a state of the processing machine and a state of a surrounding environment as a state variable indicating a current state of the environment; a determination data acquisition unit acquiring determination data indicating the processing result; and a learning unit associating the change in state quantity indicating the processing state with the processing result by using the state variable and the determination data and learning the relationship therebetween.

In the controller according to an embodiment Of the invention, the determination data includes an inspection result of the processed workpiece.

In the controller according to an embodiment of the invention, the learning unit calculates the state variable and the determination data with a multilayer structure.

A controller according to an embodiment of the invention further includes a determination output unit predicting the processing result on the basis of the state quantity learned by the learned unit during the processing of the workpiece on the basis of a learning result by the learning unit and outputting a notification prompting interruption of the processing in a case where it is predicted that the processing result becomes “failure”.

In the controller according to an embodiment of the invention, the determination output unit outputs a countermeasure for avoiding processing failure in addition to the notification or instead of the notification.

In the controller according to an embodiment of the invention, the learning unit learns the relationship between the change in state quantity indicating the processing state in the processing machine and the processing result by using the state variable and the determination data obtained for each of the plurality of processing machines.

In the controller according to an embodiment of the invention, the machine learning device is adapted to be arranged in a cloud computing environment, a fog computing environment, or an edge computing environment.

A machine learning device according to an embodiment of the invention is a machine learning device learning a relationship between a change in state quantity indicating a processing state in processing a workpiece by a processing machine and a processing result, the machine learning device including: a state observation unit observing time-series data of the state quantity including at least one of a state of the processing machine and a state of a surrounding environment as a state variable indicating a current state of the environment; a determination data acquisition unit acquiring determination data indicating the processing result; and a learning unit associating the change in state quantity indicating the processing state with the processing result by using the state variable and the determination data and learning the relationship between.

According to the invention, it is possible to provide a controller and a machine learning device capable of predicting influence of a change in state quantity on a processing result by machine learning.

### BRIEF DESCRIPTION OF THE DRAWINGS

The foregoing and other objects and features of the invention will become apparent from the following description of embodiments with reference to the accompanying drawings. Among the figures:

FIG. 1 is a block diagram illustrating a configuration of a controller;

FIG. 2 is a block diagram illustrating a configuration of a controller;

FIG. 3 is a block diagram illustrating a configuration of a controller;

FIG. 4A is a diagram illustrating a neuron;

FIG. 4B is a diagram illustrating a neural network;

FIG. 5 is a block diagram illustrating a configuration of a controller;

FIG. 6 is a block diagram illustrating a configuration of a control system;

FIG. 7 is a flowchart illustrating operations of a controller; and

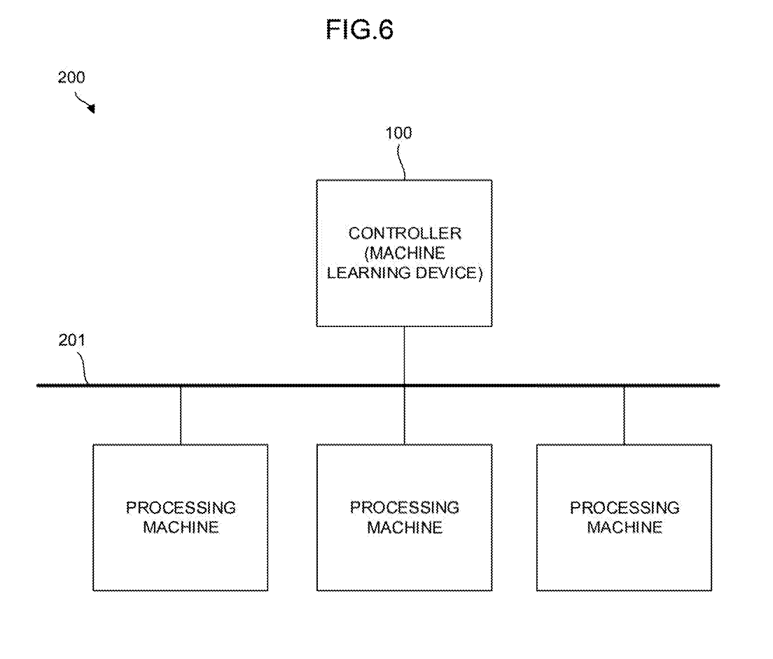

FIG. 5 is a flowchart illustrating a configuration of a controller.

### DETAILED DESCRIPTION OF THE PREFERRED EMBODIMENTS

Embodiments of the invention will be described with reference to the drawings.

A controller 100 according to the embodiment of the invention is an information processing device, and performs a procedure (learning procedure) of collecting a change in state quantity in processing of a workpiece and a processing result and modeling a relationship between the change in state quantity and the processing result by machine learning. In addition, a procedure (prediction procedure) of observing the change of the state quantity during the processing of the workpiece and predicting the processing result is performed by using the model generated in the learning procedure. The controller 100 may be a device (a numerical controller, a robot controller, or the like) which controls a processing machine (including, for example, a machine tool such as a cutting machine, an injection molding machine, a robot for finishing machining, and all kinds of machines for processing a workpiece). Alternatively, the controller may be an information processing device independent of the controller of the processing machine.

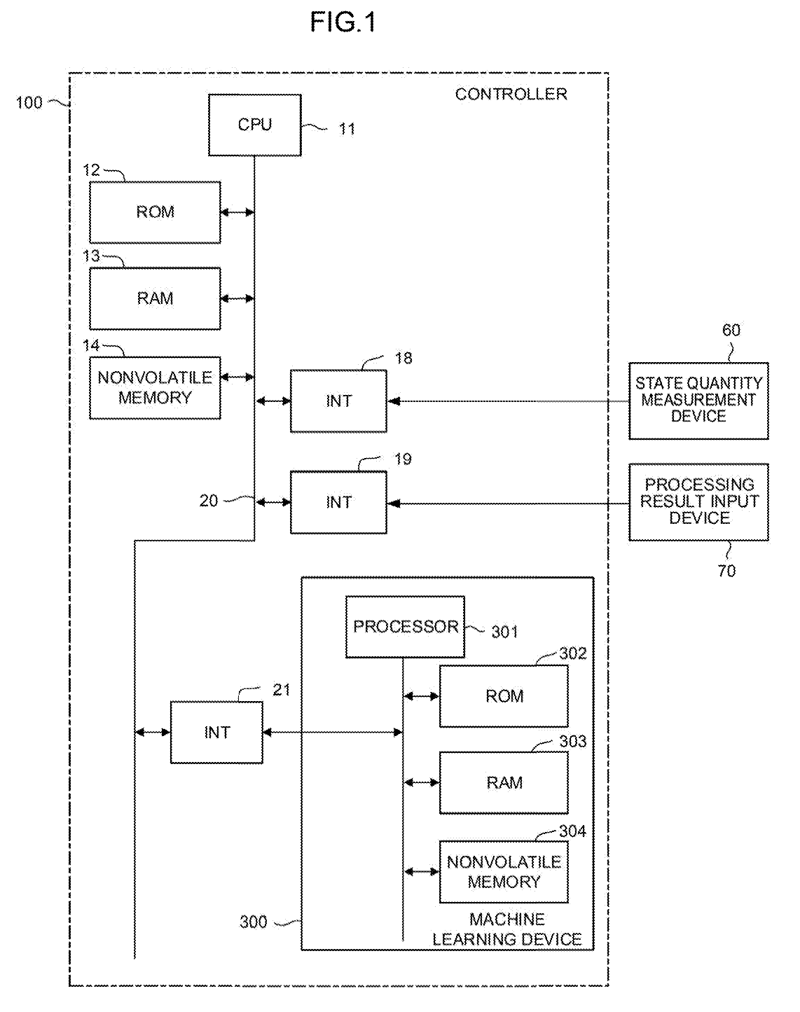

FIG. 1 is a schematic hardware configuration diagram illustrating main components of the controller 100. A CPU 11 is a processor that controls the controller 100 as a whole. The CPU 11 reads the system program stored in a ROM 12 via a bus 20 and controls the entire controller 100 according to the system program. Temporarily calculated data, display data, various types of data input from the outside, and the like are temporarily stored in a RAM 13.

A nonvolatile memory 14 is configured as a memory that is maintained in a storage state, for example, by being backed up by a battery (not illustrated) even in a case where the power supply of the controller 100 is turned off. Various programs and data input via an interface (not illustrated) are stored. The programs and data stored in the nonvolatile memory 14 may be developed in the RAM 13 at the time of execution/use. In addition, various system programs are written in the ROM 12 in advance.

A state quantity measurement device 60 measures various state quantities during processing at predetermined time intervals and outputs the state quantities. The state quantity is information indicating the processing state and includes information on the surrounding environment of the processing machine and the state of the processing machine. The state quantity is a measured value of, for example, an ambient temperature during processing, a temperature of the processing machine, an override amount, a motor current value, a motor load, a voltage or current of an input power source, sound, light, vibration, and the like generated during processing, or the like. The state quantity measurement device 60 can acquire measured values of the ambient temperature, the sound, the light, and vibration by, for example, a temperature sensor, a thermography, a microphone, a light sensor, an imaging device, an acceleration sensor, or the like. In addition, the state quantity measurement device 60 can acquire a value indicating the motor current value, the motor load, the voltage or current of the input power source, or the like from the controller of the processing machine. The state quantity measurement device 60 can simultaneously acquire a plurality of types of state quantities S1, S2, S3, . . . . The controller 100 receives the state quantity from the state quantity measurement device 60 via an interface 18, and transfers the state quantity to the CPU 11.

A processing result input device 70 generates the evaluation value of the processing result of the processed workpiece. The processing result input device 70 is, for example, an inspection device, which measures the dimensions of each portion of the processed workpiece, compares the dimensions with requested dimensions, and outputs the result of the acceptability determination as a processing result. Alternatively, the processing result input device 70 may be an input device, which receives, as an input, a result of acceptability determination obtained by a skilled inspector or the like inspecting a processed workpiece directly or via a file and outputs the result as a processing result. The controller 100 receives the processing result from the processing result input device 70 via an interface 19, and transfers the processing result to the CPU 11.

An interface 21 is an interface for connecting the controller 100 and a machine learning device 300. The machine learning device 300 includes a processor 301 which controls the entire machine learning device 300, a ROM 302 which stores system programs and the like, a RAM 303 Which temporarily stores each process related to machine learning, and a nonvolatile memory 304 which is used to store a learning model and the like. The machine learning device 300 can observe each information (state quantity, processing result, or the like) that can be acquired by the controller 100 via the interface 21.

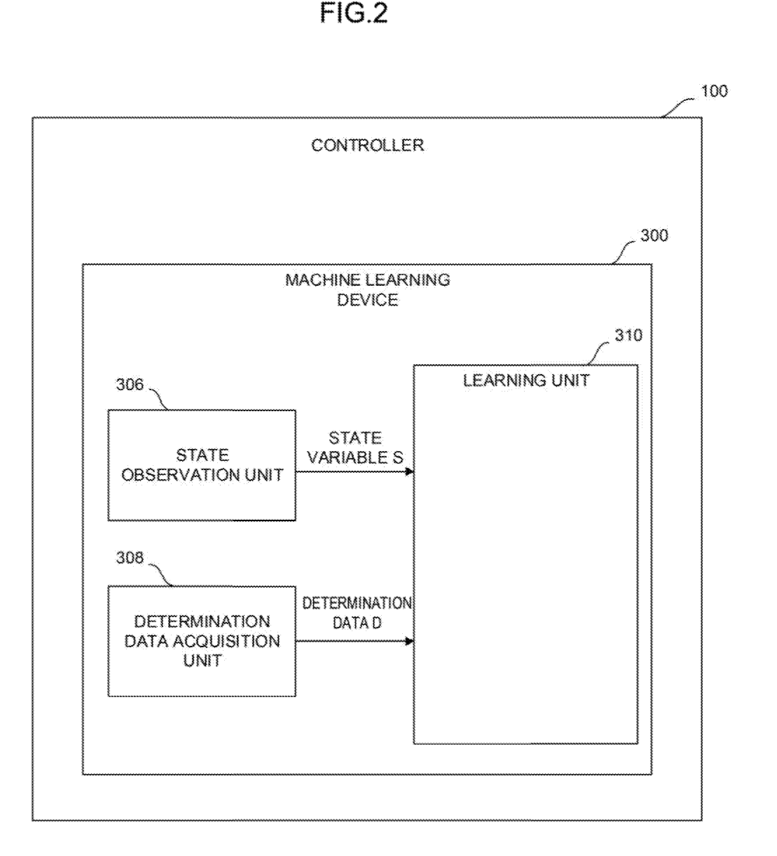

FIG. 2 is a schematic function block diagram of the controller 100 and the machine learning device 300. The machine learning device 300 includes software (such as a learning algorithm) and hardware (such as the processor 301) for learning the correlation between the change in state quantity and the processing result by so-called machine learning by itself. The learning by the machine learning device 300 of the controller 300 corresponds to a model structure representing the correlation between the change in state quantity and the processing result.

As illustrated in the function blocks in FIG. 2, the machine learning device 300 included in the controller 100 includes a state observation unit 306 which observes time-series data of state quantities as state variables S indicating the current state of the environment, a determination data acquisition unit 308 which acquires the processing result as the determination data D, and a learning unit 310 which learns the change of the state quantity and the processing result in association with each other by using the state variable S and the determination data D.

The state observation unit 306 can be configured as, for example, one function of the processor 301. Alternatively, the state observation unit 306 can be configured as, for example, software stored in the ROM 302 for causing the processor 301 to function. The time-series data of the state variable S, that is, the state quantity observed by the state observation unit 306 can be acquired from the output of the state quantity measurement device 60. The state quantity measurement device 60 extracts the time-series data of one or more state quantities acquired in a predetermined time zone from the time-series data of the state quantity acquired in a predetermined sampling cycle and outputs the time-series data as the state variable S to the state observation unit 306. For example, the state quantity measurement device 60 outputs, as the state variable S, a data set (vector) obtained by arranging the sampling data of the state quantity acquired in n minutes from the start of processing in time series. In addition, in a case where the state quantity measurement device 60 has acquired the plurality of state quantities S1, S2, S3, . . . , a set of the time-series data of the plurality of state quantities is output as the state variable S.

The determination data acquisition unit 308 can be configured as, for example, one function of the processor 301. Alternatively, the determination data acquisition unit 308 can be configured as, for example, software stored in the ROM 302 for causing the processor 301 to function. The determination data D observed by the determination data acquisition unit 308, that is, the processing result can foe acquired from the output of the processing result input device 70.

The learning unit 310 can be configured as, for example, one function of the processor 301. Alternatively, the learning unit 310 can be configured as, for example, software stored in the ROM 302 for causing the processor 301 to function. The learning unit 310 learns the correlation between the change in state quantity and the processing result according to an arbitrary learning algorithm collectively called machine learning. The learning unit 310 can iteratively execute learning based on the data set including the state variable S and the determination data D described above.

By repeating such a learning cycle, the learning unit 310 can automatically identify a feature that implies the correlation between the change in state quantity and the processing result. At the start of the learning algorithm, the correlation between the change in state quantity and the processing result is substantially unknown, but with the progress of the learning, the learning unit 310 gradually identifies the feature and interprets the correlation. When the correlation between the change in state quantity and the processing result is interpreted up to a level that is reliable to some extent, the learning result that the learning unit 310 iteratively outputs can be used to estimate what the processing result with respect to the current state (change in state quantity) is to be. That is, with the progress of the learning algorithm, the learning unit 310 can allow the correlation between the change in state quantity and the processing result to be gradually closer to an optimum solution.

As described above, in the machine learning device 300 included in the controller 100, the learning unit 310 learns the processing result according to the machine learning algorithm by using the state variable S observed by the state observation unit 306 and the determination data D acquired by the determination data acquisition unit 308. The state variable S is configured with data which is not easily influenced by an external disturbance, and the determination data D is uniquely obtained. Therefore, according to the machine learning device 300 included in the controller 100, it is possible to automatically and accurately obtain the processing result corresponding to the change in state quantity by using the learning result of the learning unit 310 without calculation or estimation.

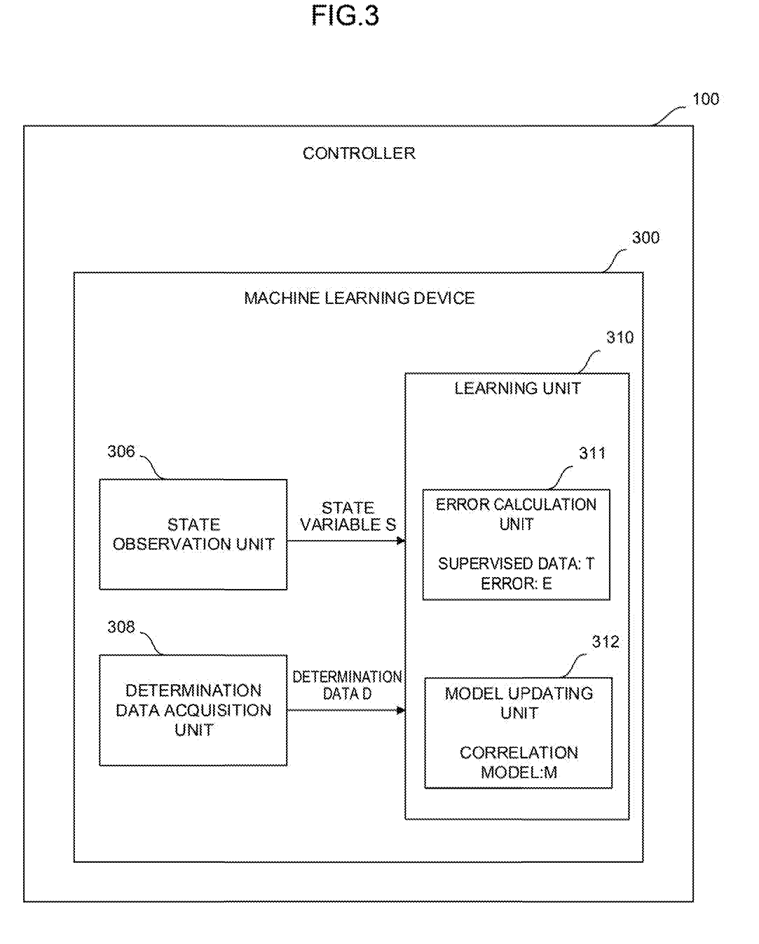

In the machine learning device 300 having the above-described configuration, the learning algorithm executed by the learning unit 310 is not particularly limited, and a well-known learning algorithm as machine learning can be adopted. FIG. 3 illustrates one mode of the controller 100 illustrated in FIG. 2 and a configuration in which the controller includes a learning unit 310 which executes supervised learning as an example of a learning algorithm. The supervised learning is a method of learning a correlation model for estimating required output (processing result for a change in state quantify) for a new input by allocating a larger amount of existing data set (referred to as supervised data) of an input and a corresponding output in advance and identifying a feature that implies the correlation between the input and the output from the supervised data.

In the machine learning device 300 included in the controller 100 illustrated in FIG. 3, the learning unit 310 includes an error calculation unit 311 which calculates an error E between the correlation model M for deriving the processing result from the state variable S and the correlation feature identified from prepared supervised data T in advance and a model updating unit 312 which updates the correlation model M so that the error E becomes small. The model updating unit 312 repeats the updating of the correlation model M, so that the learning unit 310 learns the correlation between the change in state quantity and the processing result.

The correlation model M can be configured by regression analysis, reinforcement learning, deep learning, and the like. Before starting supervised learning, an initial value of the correlation model M is allocated to the learning unit 320, for example, by simplifying expression of the correlation between the state variable S and the shape data. For example, the supervised data T can be configured by experience values (existing data sets of the change in state quantity and the processing result) accumulated by recording the correlation between the change in state quantity and the processing results in the past, and the supervised data is allocated to the learning unit 310 before the start of supervised learning. The error calculation unit 311 identifies a correlation feature that implies the correlation between the change in state quantity and the processing result from a large amount of the supervised data T allocated to the learning unit 310 and obtains an error E between the correlation feature and the correlation model M corresponding to the state variable S in the current state. The model updating unit 312 updates the correlation model M in a direction in which the error E is decreased in accordance with, for example, a predetermined updating rule.

In the next learning cycle, by using the state variables S and the determination data D obtained by executing the processing step and the inspection step for the workplace in accordance with the updated correlation model M, the error calculation unit 311 calculates the error E related to the correlation model M corresponding to the state variables S and the determination data D, and the model updating unit 312 updates the correlation model M again. In this manner, the correlation between the current state (change in state quantity) of the unknown environment and the corresponding state (processing result) is gradually clarified. That is, by updating the correlation model M, the relationship between the change in state quantity and the processing result is allowed to be gradually close to the optimum solution.

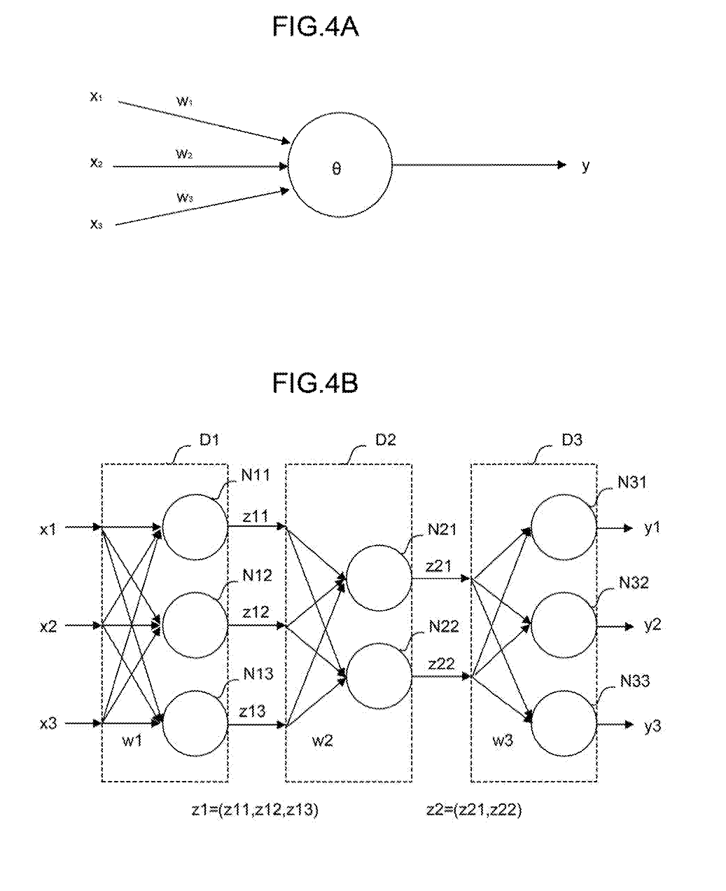

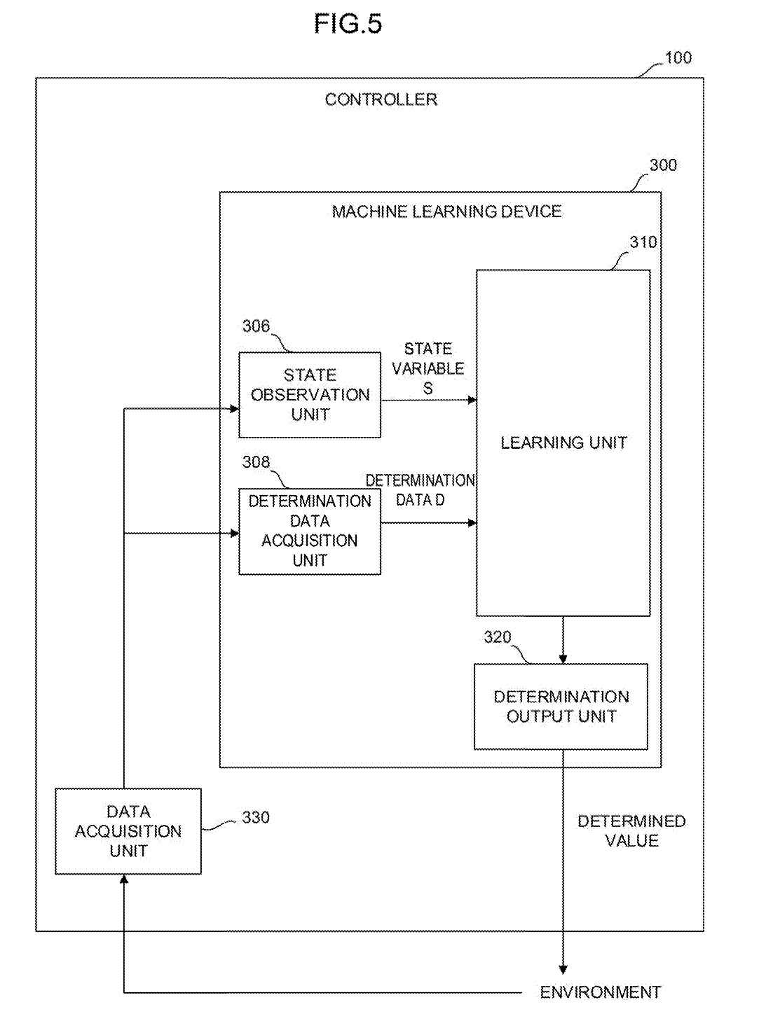

For example, a neural network can be used for proceeding of the supervised learning described above. FIG. 4A schematically illustrates a model of a neuron. FIG. 4B schematically illustrates a model of a three-layer neural network configured by combining the neurons illustrated in FIG. 4A. The neural network can be configured with, for example, a calculation unit, a storage unit, or the like imitating a model of a neuron.

The neuron illustrated in FIG. 4A outputs a result yₖ for a plurality of inputs x (herein, inputs x₁ to x₃ as an example). Each of the inputs x₁ to x₃ is multiplied by a weight w (w₁ to w₃) corresponding to the input x. Therefore, the neuron outputs an output y expressed by the following Mathematical Formula 1. In addition, in Mathematical Formula 1, the input x, the output y, and the weight w are all vectors. In addition, θ is a bias, and fₖ is an activation function.

y=fₖ(Σᵢ₋₁ⁿxᵢwᵢ−θ) [Mathematical Formula 1]

In the three-layer neural network illustrated in FIG. 4B, a plurality of inputs x (herein, inputs x1 to x3 as an example) are input from the left side, and results y (results y1 to y3 in this example) are output from the right side. In the illustrated example, each of the inputs x1, x2, and x3 is multiplied by a corresponding weight (represented by a vector w1), and each of the inputs x1, x2, and x3 is input to three neurons N11, N12, and N13.

In FIG. 4B, the output of each of the neurons N11 to N13 is represented by a vector z1. z1 can be considered to be a feature vector obtained by extracting a feature quantity of an input vector. In the illustrated example, each of the feature vectors z1 is multiplied by a corresponding weight (represented by a vector w2), and each individual feature vector z1 is input to two neurons N21 and N22. The feature vector z1 represents a feature between the weight w1 and the weight w2.

In FIG. 4B, the output of each of the neurons N21 to N22 is represented by a vector z2. z2 can be considered to be a feature vector obtained by extracting a feature quantity of the feature vector z1. In the illustrated example, each of the feature vectors z2 is multiplied by a corresponding weight (represented by vector w3), and each individual feature vector z2 is input to three neurons N31, N32, and N33. The feature vector z2 represents a feature between the weight w2 and the weight w3. Finally, the neurons N31 to N33 output the results y1 to y3, respectively.

In the machine learning device 300 included in the controller 100, the learning unit 310 performs calculation of a multilayer structure according to the above-described neural network with the state variable S as the input x, so that the processing result can be output as the estimated value (result y). In addition, the operation mode of the neural network includes a learning mode and a determination mode. Therefore, for example, the weight W can be learned by using the learning data set in the learning mode, and the shape data can be determined in the determination mode by using the learned weight W. In the determination mode, detection, classification, inference, or the like can also be performed.

The configuration of the controller 100 and the machine learning device 300 can be described as a machine learning method (or software) executed by the CPU 11 or the processor 301. This machine learning method is a machine learning method for learning a processing result corresponding to a change in state quantity and includes a step in which the CPU 11 or the processor 301 observes the change in state quantity as a state variable S indicating the current state of the environment, a step of acquiring the processing result as determination data D, and a step of learning the change in state quantity and the processing result in association with each other by using the state variable S and the determination data D.

According to this embodiment, the machine learning device 300 generates a model representing the correlation between the change in state quantity and the processing result. Therefore, once the learning model is generated, it is possible to predict the processing result on the basis of the change in state quantity that can be acquired up to that time point even during the processing.

FIG. 5 illustrates a controller 100 according to a second embodiment. The controller 100 includes a machine learning device 300 and a data acquisition unit 330. The data acquisition unit 330 acquires time-series data of a state quantity and a processing result from a state quantity measurement device 60 and a processing result input device 70.

In addition to the configuration of the machine learning device 300 according to the first embodiment, the machine learning device 300 included in the controller 100 includes a determination output unit 320 which outputs the processing result estimated by a learning unit 310 as data such as characters, images, sounds, voice, or the like, or data in an arbitrary format on the basis of the change in state quantity.

The determination output unit 320 can be configured as, for example, one function of a processor 301. Alternatively, the determination output unit 320 can be configured as, for example, software for causing the processor 301 to function. The determination output unit 320 outputs the processing result estimated on the basis of the change in state quantity by the learning unit 310 to the outside as characters, images, sounds, voice, or the like, or data in an arbitrary format. For example, in a case where the processing result is estimated to indicate “rejected”, the determination output unit 320 outputs a notification prompting the user to interrupt the processing. Alternatively, a notification indicating that “rejected” is predicted may be simply issued.

The machine learning device 300 included in the controller 100 having the above-described configuration has the same effect as the machine learning device 300 described above. In particular, the machine learning device 300 according to the second embodiment can change the state of the environment by the output of the determination output unit 320. On the other hand, in the machine learning device 300 according to the first embodiment, the function corresponding to the determination output unit 320 for reflecting the learning result of the learning unit 110 to the environment can be obtained from an external device.

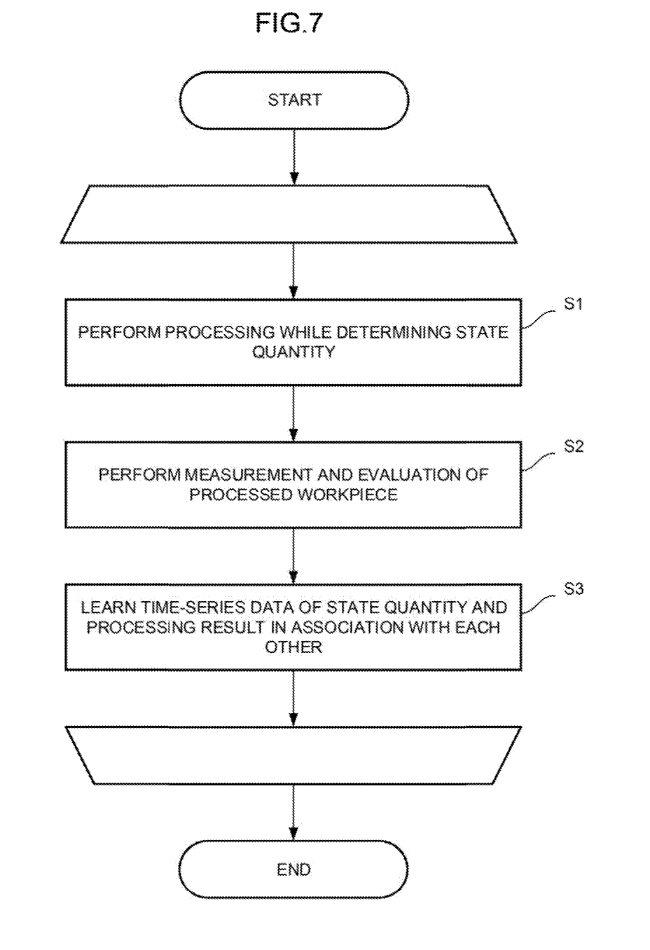

FIG. 6 illustrates a control system 200 with a plurality of processing machines. The control system 200 includes a controller 100, a plurality of processing machines having the same machine configuration, and a network 201 which connects the processing machines and the controller 100 to each other. Each of the processing machines may independently include a controller, or a plurality of processing machines may share one controller (for example, the controller 100).

In the control system 200 having the above-described configuration, the controller 100 can learn the correlation between the change in state quantity and the processing result common to all the processing machines on the basis of the state variable S and the determination data D obtained for each of the plurality of processing machines.

The control system 200 can have a configuration in which the controller 100 exists in a cloud server or the like prepared in the network 201. Alternatively, the controller 100 may be arranged in a fog computing environment, an edge computing environment, or the like. According to this configuration, it is possible to connect the necessary number of processing machines to the controller 100 when necessary, irrespective of the location and timing of each of the plurality of processing machines.

### Example 1

As Example 1, processes of a controller 100 generating a learning model of a correlation between a change in state quantity and a processing result (learning procedure) and predicting the processing result during the processing by using the learning model (prediction procedure) will be described.

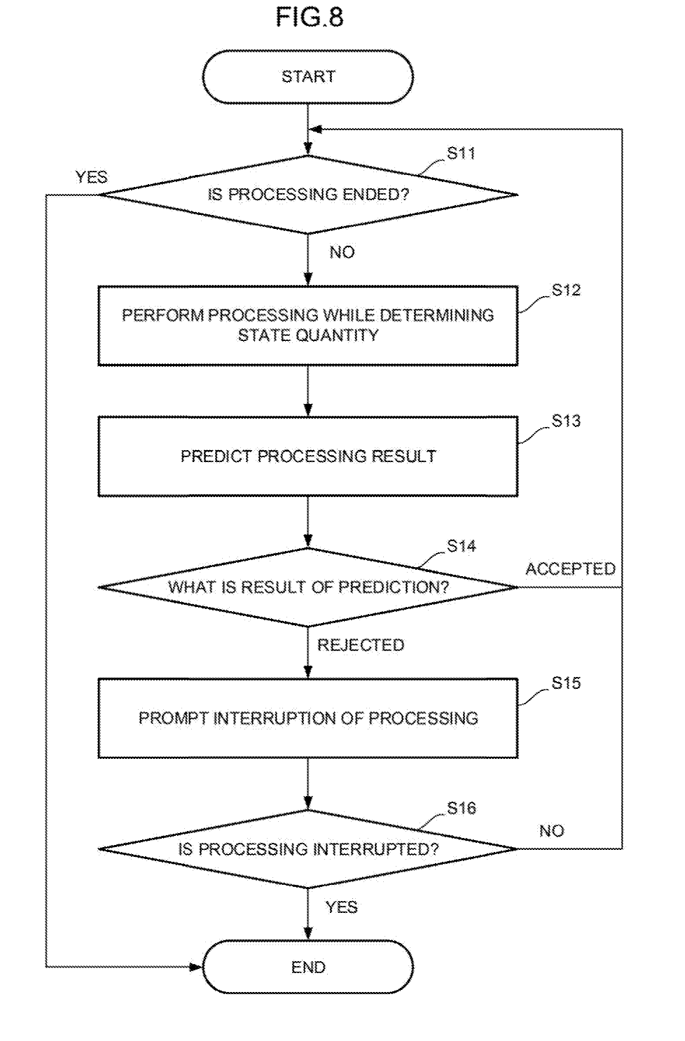

The operations in the learning procedure of the controller 100 will be described with reference to a flowchart of FIG. 7.

S1: A processing machine starts processing a workpiece. The controller 100 starts measuring a state quantity at a predetermined sampling cycle simultaneously with the start of processing. The controller 100 acquires the state quantity for a predetermined time at a preset timing and stores the state quantity.

S2: A measurement device inspects the processed workpiece. The controller 100 acquires the processing result from the measurement device and stores the processing result.

S3: The controller 100 sets time-series data of the state quantity acquired in step S1 as a state variable S, inputs the processing result acquired in step 22 as determination data D to a machine learning device 300, and generates a learning model representing a correlation between the state variable S and the determination data D.

The controller 100 repeats the processes from step 31 to step S3 until the number of state variables S and determination data D sufficient to obtain a learning model with a desired accuracy is obtained. In addition, in this learning procedure, every time one workpiece is processed, one learning cycle (processes of steps S1 to S3) is performed.

Subsequently, the operations in the prediction procedure of the controller 100 will be described with reference to a flowchart of FIG. 8.

S11: The processing machine starts processing the workpiece. In addition, when the processing is completed, the processes in the prediction procedure are also ended.

S12: The controller 100 starts measuring the state quantity at a predetermined sampling cycle simultaneously with the start of processing. The controller 100 acquires the state quantity for a predetermined time at a preset timing and stores the state quantity.

S13: The controller 100 inputs time-series data of the state quantity acquired in step S12 as a state variable S to the machine learning device 300. The machine learning device 300 inputs the state variable S to the learning-completed model and outputs the determination data D corresponding to the state variable S as a predicted value.

S14: In a case where the predicted value indicates “accepted”, the process returns to step S11, and the processing is continued. In a case where the predicted value indicates “rejected”, the process proceeds to step S15.

S15: The controller 100 outputs a notification prompting interruption of the processing to the user.

S16: In a case where the processing is interrupted, the process is ended. In a case where the processing is resumed, the process returns to step S11, and the process is continued.

In Example 1, the machine learning device 300 of the controller 100 generates a learning model in which the correlation between the change in state quantity and the processing result in a predetermined time after the start of processing is learned. By using this learning model, the controller 100 can predict the processing result on the basis of the change in state quantity during the processing and notify the user of the prediction result.

### Example 2

In a configuration of Example 2, in addition to or instead of prompting interruption of the processing in a case where the controller 100 predicts that the processing result indicates “rejected”, an appropriate countermeasure is presented in order to avoid the processing failure. For simplifying the description, only differences from Example 1 will be described.

In step S1 of the flowchart of FIG. 1, the controller 100 has a plurality of state quantity acquisition times. For example, time-series data of the state quantity of 1 minute, 5 minutes, and 10 minutes from the start of processing are obtained.

In step S3, the controller 100 inputs a set of each of the plurality of time-series data acquired in step S1 and the determination data D into the machine learning device 300. That is, three types of data sets for learning obtained by setting the time-series data of the state quantity for 1 minute from the start of processing as a state variable S, setting the time-series data of the state quantity for 5 minutes from the start of processing as a state variable S, and setting the time-series data of the state quantity for 10 minutes from the start of processing as a state variable S are allocated to the machine learning device 300.

In addition, in step S12 of the flowchart of FIG. 8, similarly to step S1, a plurality of state quantity acquisition times are provided. For example, the controller 100 acquires time-series data of state quantities for 1 minute, 5 minutes, and 10 minutes from the start of processing.

In step S13, the controller 200 inputs each of the plurality of time-series data acquired in step S12 to the machine learning device 300. That is, three types of data sets for estimation obtained by setting the time-series data of the state quantity for 1 minute from the start of processing as a state variable S, setting the time-series data of the state quantity for 5 minutes from the start of processing as a state variable S, and setting the time-series data of the state quantity for 10 minutes from the start of processing as a state variable S are allocated to the machine learning device 300.

In steps S14 and S15, in a case where the prediction result with respect to all the data sets for estimation indicates “rejected”, the controller 100 prompts the user to interrupt the processing. On the other hand, in a case where the prediction result with respect to a certain data set for estimation indicates “rejected” but the prediction result with respect to another data set for estimation indicates “accepted”, the controller 200 presents, to the user, a change of the state quantity in the data set for estimation of which the prediction result indicates “accepted”.

For example, it is assumed that, the prediction result in a case where the time-series data of the state quantity for 1 minute from the start of processing is set as the state variable S indicates “rejected” (referred to as a scenario A), and the prediction result in a case where the time-series data of the state quantity for 5 minutes from the start of processing is set as the state variable S indicates “accepted” (scenario A′). This indicates that, if the processing is continued in the state of scenario A, there is a high possibility that the processing failure occurs, but exceptionally if the state quantity is changed as in scenario A′, there is a high possibility that the processing result is turned to be “good”. Therefore, the controller 100 according to this embodiment presents the feature of the transition of the state quantity in the scenario A′ to the user as a countermeasure for avoiding the processing failure. For example, it is possible to display a graph illustrating a change of state quantity with time or to display a statistical quantity (an average value, a median value, a maximum value, a minimum value, or the like) of the state quantity in the scenario A′. In this case, in a case where a plurality of state quantities S1, S2, S3, . . . are included in the state variable S of the scenario A′, a dominant state quantity Sx may be specified among the state quantities, and only the feature of the transition of the state quantity Sx may be presented to the user. Since the extraction of the dominant state quantity can be realized by a well-known technique, the detailed description thereof will be omitted herein.

Although the embodiments of the invention have been described heretofore, the invention is not limited to the examples of the above-described embodiments, but the invention can be implemented as other modes by applying appropriate changes.

For example, in the above-described embodiment, the controller 100 performs learning by using the state quantity and the inspection result obtained when continuously processing the same type of workpiece. Herein, the same type of workpiece is not necessarily a workpiece having the same shape. For example, a workpiece having a similar shape such as a different tap diameter may be used as a learning object. In addition, although workplaces which are the same or similar in shape but different in material, workpieces which are greatly different in shape, and the like are not necessarily the same type of workpieces, in this case, a variable for identifying the material or the shape can be input as one state variable S. Therefore, even with respect to the workpieces which are different in material or shape, it is possible to perform learning with one model during a series of learning procedures.

Although the embodiments of the invention have been described heretofore, the invention is not limited to the examples of the above-described embodiments, but the invention can be implemented as other modes by applying appropriate changes.

1. A controller predicting a processing result for a workplace by a processing machine, the controller comprising a machine learning device learning a relationship between a change in state quantity indicating a processing state and a processing result,
wherein the machine learning device includes:
a state observation unit observing time-series data of the state quantity including at least one of a state of the processing machine and a state of a surrounding environment as a state variable indicating a current state of the environment;
a determination data acquisition unit acquiring determination data indicating the processing result; and
a learning unit associating the change in state quantity indicating the processing state with the processing result by using the state variable and the determination data and learning the relationship therebetween.

2. The controller according to claim 1, wherein the determination data includes an inspection result of the processed workpiece.

3. The controller according to claim 1, wherein the learning unit calculates the state variable and the determination data with a multilayer structure.

4. The controller according to claim 1, further comprising a determination output unit predicting the processing result on the basis of the state quantity learned by the learning unit during the processing of the workpiece and outputting a notification prompting interruption of the processing in a case where it is predicted that the processing result indicates “failure”.

5. The controller according to claim A, wherein the determination output unit outputs a countermeasure for avoiding processing failure in addition to the notification or instead of the notification.

6. The controller according to claim 1, wherein the learning unit learns the relationship between the change in state quantity indicating the processing state in the processing machine and the processing result by using the state variable and the determination data obtained for each of the plurality of processing machines.

7. The controller according to claim 1, wherein the machine learning device is adapted to be arranged in a cloud computing environment, a fog computing environment, or an edge computing environment.

8. A machine learning device learning a relationship between a change in state quantity indicating a processing state in processing a workpiece by a processing machine and a processing result, the machine learning device comprising:
a state observation unit observing time-series data of the state quantity including at least one of a state of the processing machine and a state of a surrounding environment as a state variable indicating a current state of the environment;
a determination data acquisition unit acquiring determination data indicating the processing result; and
a learning unit associating the change in state quantity indicating the processing state with the processing result by using the state variable and the determination data and learning the relationship therebetween.
